(19) United States
(12) Patent Application Publication
(10) Pub. No.: US 2026/0159450 A1
(43) Pub. Date: Jun. 11, 2026

(54) MULTICOLOURED CERAMIC COMPONENT AND ITS MANUFACTURING METHOD

(71) Applicant: Comadur SA, Le Locle (CH)

(72) Inventors: Arnaud ACTIS-DATTA, Bassecourt (CH); Sébastien RETROUVEY, Chissey sur Loue (FR); Nicolas OIAN, Grimisuat (CH); Pierry VUILLE, Les Emibois (CH)

(73) Assignee: Comadur SA, Le Locle (CH)

(21) Appl. No.: 19/374,285

(22) Filed: Oct. 30, 2025

(30) Foreign Application Priority Data
Dec. 9, 2024 (EP) 24218403.4

(51) Int. Cl. C04B 35/64; B28B 1/00; B28B 11/24; C04B 35/626; G04D 3/00

(52) U.S. Cl. CPC C04B 35/64; B28B 1/008; B28B 11/243; C04B 35/6261; C04B 35/6264; C04B 35/62655; G04D 3/0069; C04B 2235/446; C04B 2235/6567; C04B 2235/666

(57) ABSTRACT

A multicoloured ceramic component and its manufacturing method.

### CROSS REFERENCE TO RELATED APPLICATIONS

This application claims priority to European Patent Application No. 24218403.4, filed on Dec. 9, 2024, the entire contents of which are incorporated herein by reference.

### TECHNICAL FIELD

The present invention relates to a ceramic component. It relates more specifically to a horology component produced by spark plasma sintering (SPS) coloured ceramic materials to form a multicoloured, one-piece horology component.

### PRIOR ART

Ceramic or cermet horology components are generally produced using an injection moulding method or a method involving uniaxial or isostatic pressing of a material, followed by sintering. These components often feature decorations, such as indexes and numerals on a dial or a bezel, in a colour that is different from the rest of the component, or simply a two-tone decoration throughout. Decorative elements on bezels are generally added by inlaying or filling the sintered ebauche. This mechanical assembly between the ebauche and the decorative elements can be costly and complicated to use.

One alternative to this mechanical assembly is to produce an ebauche by injecting differently-coloured materials, the colour used to form the decoration being revealed after machining. However, manufacturing ceramic or cermet components in different colours is a complex process. For example, document JP59910502 describes an injection moulding process using ceramic powders combined with an organic binder. Such a method has the drawback of being complex to use as it comprises numerous steps, in particular the preparation of the powder comprising a binder, which requires a debinding step, as well as one or more supplementary steps to obtain the desired final colour.

Document EP 2 965 713 also describes a method for obtaining a ceramic material with a colour progression and forming a dental prosthesis. However, such a method uses isostatic pressing, which is generally time-consuming and demanding.

### SUMMARY OF THE INVENTION

The present invention aims to remedy the aforementioned drawbacks by proposing a new manufacturing method for producing a multicoloured ceramic component.

To this end, the present invention relates to a method for manufacturing a multicoloured ceramic component.

More specifically, the method for manufacturing the multicolour component according to the invention comprises the following steps:
preparing several ceramic or cermet powders, the ceramic powders differing from each other in their composition and/or colour, the powders comprising only ceramic elements, carbides, nitrides, oxides or a mixture of these elements;
providing a mould;
depositing the powders in the mould;
performing a flash sintering or spark plasma sintering cycle at a sintering temperature comprised between 600° C. and 1,800° C. and a sintering pressure comprised between 5 N/mm2 and 250 N/mm2, for a complete cycle time comprised between 10 minutes and 180 minutes, to form a multicoloured ceramic component;
unmoulding the resulting multicoloured component;
applying a finish to the multicoloured ceramic component.

The present invention also relates to the multicoloured ceramic component produced by the manufacturing method.

According to other advantageous variants of the invention:
the unmoulding step is followed by a thermal treatment such as annealing at between 550 and 1,100° C., and for between 30 minutes and 8 hours in stages in air or reagent gas;
the ceramic or cermet powders are chosen among: a zirconium oxide powder, an aluminium oxide powder, a titanium nitride powder, a silicon nitride powder, a titanium carbide powder, a tungsten carbide powder or a mixture of at least two of these powders;
one or more ceramic powders comprise one or more distinct pigments giving a different colour to the ceramic;
the pigment is a cerium sulphide;
the pigment is a metal oxide, a perovskite or a spinel;
the pigment is chosen among a chromium oxide, a cobalt oxide, an iron oxide, a titanium oxide, a manganese oxide, a molybdenum oxide, a cerium oxide, a vanadium oxide, a zinc oxide, an aluminium oxide or a mixture of these oxides;
a cobalt/iron/chromium spinel or a cobalt/aluminium spinel;
the method comprises a powder preparation step in which the powders are mixed, homogenised or ground in a water-based or alcohol-based solution;
the ceramic powders are atomised after the powder preparation step;
the powders are deposited in the mould by a selective powder deposition system to form several layers, each deposited layer comprising several powders;
a grid is placed in the mould before the mould filling step;
the sintering step is carried out in a vacuum or in an inert or reactive atmosphere.

The invention also relates to a one-piece ceramic component with a multicoloured appearance.

The component according to the invention comprises several distinct ceramic materials that differ in composition and/or colour, and more generally in their aesthetic appearance. According to the invention, the decorated component is multicoloured and made in one piece.

### BRIEF DESCRIPTION OF THE FIGURES

Other features and advantages of the invention will become apparent from the following detailed description, given by way of non-limiting example, with reference to the attached drawings in which:

FIG. 1 shows a schematic view of the manufacturing method according to the invention.

FIGS. 2a to 2c respectively illustrate examples of multicoloured ceramic components produced using the manufacturing method according to the invention.

### DETAILED DESCRIPTION

The present invention relates to a ceramic component such as an external part used in horology or in jewellery, or even a horology component with a multitude of colours throughout its entire mass.

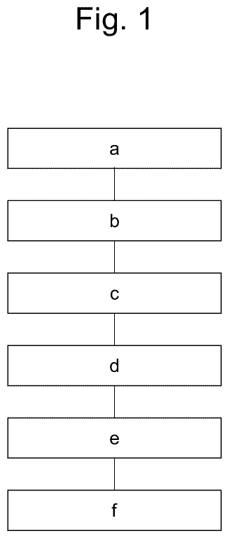

The method according to the invention is schematically illustrated in FIG. 1. The method is characterised by an assembly, such as a juxtaposition and/or a stack, of various “raw” powders, followed by a step in which all of the powders are sintered.

In this description, “raw” powder means a powder that does not comprise any polymer binder.

The component according to the invention is made of ceramic. For example, it can be a ceramic made from a zirconium oxide, an aluminium oxide, a titanium nitride, silicon nitride or even a carbide such as a titanium carbide or a tungsten carbide, or a mixture of these ceramics.

More generally, “ceramic” refers to a ceramic base with a stabiliser, an additive or a sintering aid and optionally a pigment. For example, for an oxide base such as ZrO2, Y2O3 can be added as a stabiliser, Al2O3 as an additive and Fe2O3 as a pigment.

At least one of the ceramic powders comprises at least one pigment for colouring the material. The pigment is a metal oxide, a spinel, a perovskite or even a cerium sulphide, the pigment being chosen according to the desired colour. Non-limiting examples include chromium oxide, cobalt oxide, iron oxide, titanium oxide, manganese oxide, zinc oxide, molybdenum oxide, cerium oxide, vanadium oxide, aluminium oxide or a mixture of these oxides such as an iron/chromium oxide, for example. For example, for a blue colour the pigment can be a cobalt oxide, for a green colour the pigment can be a chromium oxide, for a brown colour the pigment can be an iron oxide.

The component according to the invention can also be a decorative component such as a constituent element for watches, jewellery, wristlets, etc. In the horology field, this component can be an external part such as a middle, a back, a locket, a bezel, a bezel insert, a button, a crown, a wristlet link, a clasp, a buckle, a dial, a hand, a dial index, a plate, a bar, etc. It can also be a component in the movement such as an oscillating weight, a plate, etc. By way of further example, it could be an emblem on a watch crown or even an index on a bezel.

The component is made by putting various powders in a mould and then flash sintering or SPS (Spark Plasma Sintering) them to form a ceramic component with a multicoloured appearance.

The manufacturing method comprises the following steps with reference to FIG. 1:
preparing several ceramic or cermet powders, the ceramic or cermet powders differing from each other in their composition and/or colour, the powders comprising only carbides, nitrides, oxides or a mixture of these elements;
providing a mould designed to hold the ceramic powders;
filling the mould with the ceramic powders according to the desired pattern and colours, the height of the mixture of materials deposited not exceeding the height of the mould;
performing flash sintering or SPS;
unmoulding the resulting ceramic component;
applying a finish to the multicoloured ceramic component 1.

Optionally, after the unmoulding step, annealing can be carried out at between 550 and 1,100° C. and for between 30 minutes and 8 hours in stages and in air to remove any graphite covering the ebauche.

Several layers of mixed ceramic materials can be stacked or juxtaposed to form a particular colour pattern visible from the sides of the component.

According to one embodiment of the invention, a grid or chablon is placed in the mould before the mould filling step. The grid or chablon is used to compartmentalise the mould and create patterns during filling that will persist after sintering, the grid or chablon being removed before the sintering step.

According to another embodiment, the powders are deposited in the mould by a selective powder deposition system to form several layers, each deposited layer comprising several powders.

The ceramic powder is solely made up of carbides, nitrides, oxides or a mixture of these elements, and does not comprise any polymer binder.

In the powder preparation step, the powders are mixed, homogenised or ground in a water-based or alcohol-based solution. Homogenisation (or grinding) is generally carried out using an attritor or ball mill. Preferably, a water-based solution will be used if the ceramic powder contains metal oxide pigments, and an alcohol-based solution will be used for cermets.

After homogenisation, the powders are atomised or dried. Atomisation makes it possible to form particle spheres with the various components of the ceramic powder and to obtain a very homogeneous powder.

The method comprises a step d) in which the powder assembly undergoes flash sintering (or SPS) to produce a multicoloured ceramic component corresponding to the final part. The temperature and pressure conditions can be adapted according to the type of powders and/or to the expected final properties of the component 1.

According to one embodiment, the sintering step is carried out at a temperature comprised between 600° C. and 1,800° C., and in a vacuum.

The sintering step also comprises a mechanical pressure of between 5 N/mm2 and 250N/mm2 . The mechanical pressure can be constant or can have controlled variations such as various thresholds or ramps with increasing or decreasing values.

The complete cycle in the sintering stage is carried out for a time span comprised between 10 minutes and 180 minutes. A sintering cycle is taken to mean a temperature rise, a temperature hold and a temperature reduction.

The temperature is usually brought to the sintering temperature at a rate of 50° C. to 500° C. per minute.

Once sintering is complete, step e) consists of demoulding the resulting multicoloured component, the colours appearing directly after sintering.

Optionally, the unmoulding step is followed by a thermal treatment such as annealing at between 550 and 1,100° C., and for between 30 minutes and 8 hours in stages in air or reagent gas.

As required by the person skilled in the art, the component can be machined to true the dimensions after sintering.

After any sizing, the manufacturing method includes a step f) for finishing the component. The finishing step can involve one or more methods such as satin-finishing, polishing, engine turning, côte de Genàve, circular graining, hammering, mattifying, or any other method known to the skilled person.

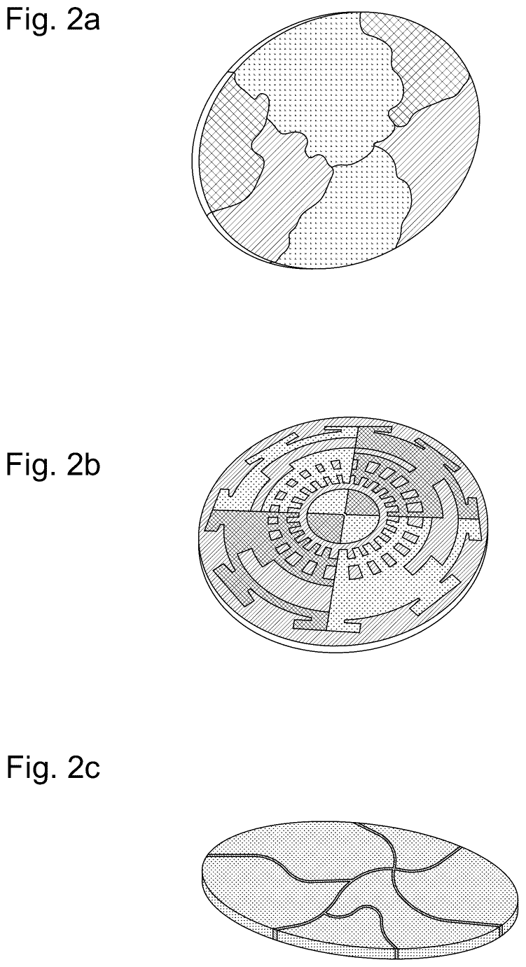

Typically, a dial 1 according to FIGS. 2a through 2c is produced using the method according to the invention, with the dial having a multicoloured appearance. Of course, other multicoloured watch components can be obtained using the method according to the invention, such as an external component used in horology or a movement component. Thus, a middle, a back, a locket, a bezel, a bezel insert, a button, a crown, a wristlet link, a buckle, a dial, a hand, a dial index, an oscillating weight, a bridge or even a plate can be produced using the method according to the invention.

1. A method for manufacturing a multicoloured, one-piece ceramic component, said method comprising the following steps:
preparing several ceramic or cermet powders, the ceramic or cermet powders differing from each other in their composition and/or their colour, the powders comprising only ceramic elements, carbides, nitrides, oxides or a mixture of these elements;
providing a mould;
depositing the powders in the mould;
performing flash sintering or spark plasma sintering at a sintering temperature comprised between 600° C. and 1,800° C. and a sintering pressure comprised between 5 N/mm2 and 250 N/mm2, for a complete cycle time comprised between 10 minutes and 180 minutes, to form a multicoloured ceramic component;
unmoulding the resulting multicoloured component;
applying a finish to the multicoloured ceramic component (1).

2. The manufacturing method according to claim 1, characterised in that the unmoulding step is followed by a thermal treatment such as annealing at between 550 and 1,100° C., and for between 30 minutes and hours in stages in air or reagent gas.

3. The manufacturing method according to claim 1, characterised in that the ceramic or cermet powders are chosen among: a zirconium oxide powder, an aluminium oxide powder, a titanium nitride powder, a silicon nitride powder, a titanium carbide powder, a chromium carbide powder, a tungsten carbide powder or a mixture of at least two of these powders.

4. The manufacturing method according to claim 1, characterised in that at least one or more ceramic powders comprise one or more distinct pigments giving the ceramic a different colour.

5. The method according to claim 1, characterised in that the pigment is a metal oxide, perovskite or spinel.

6. The method according to claim 4, characterised in that the pigment is chosen among a chromium oxide, a cobalt oxide, an iron oxide, a titanium oxide, a manganese oxide, a molybdenum oxide, a cerium oxide, a vanadium oxide, a zinc oxide, an aluminium oxide or a mixture of these oxides.

7. The method according to claim 4, characterised in that the pigment is a cobalt/iron/chromium spinel or a cobalt/aluminium spinel.

8. The method according to claim 4, characterised in that the pigment is cerium sulphide.

9. The method according to claim 1, further comprising a powder preparation step in which the powders are homogenised or ground in a water-based or alcohol-based solution.

10. The method according to claim 1, characterised in that the powders are atomised after the powder preparation step.

11. The method according to claim 1, characterised in that the powders are deposited in the mould by a selective powder deposition system to form several layers, each deposited layer comprising several powders.

12. The method according to claim 1, characterised in that a grid is placed in the mould before the mould filling step.

13. The method according to claim 1, characterised in that the sintering step is carried out in a vacuum or reagent gas.

14. A ceramic component having a multicoloured appearance.

15. The component according to claim 14, characterised in that the component is a horology component used as an external part or in the movement.

16. The component according to claim 14, characterised in that the horology component used as an external part or in the movement is chosen from the list comprising a middle, a back, a bezel, a bezel insert, a button, a crown, a wristlet link, a buckle, a dial, a hand, a dial index, an oscillating weight and a plate.
